(19) United States
(12) Patent Application Publication
(10) Pub. No.: US 2025/0380045 A1
(43) Pub. Date: Dec. 11, 2025

(54) METHOD AND SYSTEM FOR TAKING IMAGES DURING VIDEO CALLS

(71) Applicant: LINE Plus Corporation, Seongnam-si (KR)

(72) Inventors: Gye Yeong KIM, Seongnam-si (KR); Keumryong Kim, Seongnam-si (KR); Sooha Yoo, Seongnam-si (KR); Byeong Ho Lee, Seongnam-si (KR); Yeseul Kim, Seongnam-si (KR); Min Ha Son, Seongnam-si (KR)

(73) Assignee: LINE Plus Corporation, Seongnam-si (KR)

(21) Appl. No.: 19/300,208

(22) Filed: Aug. 14, 2025

Related U.S. Application Data
(63) Continuation of application No. PCT/KR2023/020962, filed on Dec. 19, 2023.

(30) Foreign Application Priority Data
Feb. 15, 2023 (KR) 10-2023-0020100

(51) Int. Cl. H04N 23/63; H04L 51/043; H04N 23/661

(52) U.S. Cl. CPC H04N 23/631; H04L 51/043; H04N 23/661

(57) ABSTRACT

A method for capturing an image during a video call includes initiating the video call between the first user terminal and a second user terminal, the first user terminal being associated with a first user, the second user terminal being associated with a second user, and the first user and the second user being included in a chat room of an instant messaging application, entering a multi-party photo capturing mode during the video call, displaying a capture notification on a display of the first user terminal for a first time period, and displaying, on the display, a composite image in which a first image and a second image are combined, the first image including the first user, and the second image including the second user.

### CROSS-REFERENCE TO RELATED APPLICATION

This application is a continuation of International Application No. PCT/KR2023/020962 filed on Dec. 19, 2023, which claims priority to Korean Patent Application No. 10-2023-0020100 filed on Feb. 15, 2023, the entire contents of each of which are herein incorporated by reference in their entireties.

### BACKGROUND

The present disclosure relates to a method and system for capturing images during a video call, and more specifically, to a method and apparatus for capturing images of users during a video call using an instant messaging application, and generating and displaying a composite image based thereon.

### DESCRIPTION OF RELATED ART

Recently, due to the spread of mobile devices such as smartphones and the development of the Internet, instant messaging applications that enable not only voice calls but also video calls between a plurality of users are being widely used. Meanwhile, the demand for so-called ‘photobooths’ that print and provide photos taken together by several people offline is steadily increasing.

However, in an image capture function provided by existing video call providing services, an image is captured in a state where a user is not prepared for image capture, or the user is burdened with directly guiding the timing at which the image is captured by voice or the like. In addition, since the existing image capture function merely involves capturing a screen of a specific moment during a video call, it is difficult to provide a user with an image to which various formats, concepts, photo themes, etc., are applied. Therefore, existing image capture services experience difficulty in providing an image that satisfies a user compared to when shooting is performed in a ‘photobooth’.

### SUMMARY

The present disclosure provides a method for capturing an image during a video call, a computer-readable non-transitory recording medium on which instructions are recorded, and a system (apparatus) for addressing the challenges described above.

The present disclosure may be implemented in various ways including a method, a system (apparatus), or a computer-readable non-transitory recording medium on which instructions are recorded.

In embodiments, a method performed by at least one processor of a first user terminal for capturing an image during a video call includes initiating the video call between the first user terminal and a second user terminal, the first user terminal being associated with a first user, the second user terminal being associated with a second user, and the first user and the second user being included in a chat room of an instant messaging application, entering a multi-party photo capturing mode during the video call, displaying a capture notification on a display of the first user terminal for a first time period, and displaying, on the display, a composite image in which a first image and a second image are combined, the first image including the first user, and the second image including the second user.

In embodiments, the method may further include receiving a user input selecting a multi-party photo capturing button from the first user based on the entering the multi-party photo capturing mode, capturing the first image using an image sensor of the first user terminal contemporaneous with the displaying the capture notification, receiving the second image from the second user terminal, and generating the composite image by combining the first image and the second image.

In embodiments, the method may further include receiving a user input for multi-party photo capturing from the first user based on the entering the multi-party photo capturing mode, capturing the first image using an image sensor of the first user terminal contemporaneous with the displaying the capture notification, acquiring a screenshot of the second image displayed on the display, and generating the composite image by combining the first image and the second image.

In embodiments, the method may further include deactivating a multi-party photo capturing button in response to determining that the second user has selected a camera-off button.

In embodiments, the method may further include displaying a capture preparation notification on the display for a second time period based on the entering the multi-party photo capturing mode, wherein the second time period is longer than the first time period.

In embodiments, the method may further include deactivating a camera-off button and a multi-party photo capturing mode exit button contemporaneous with the displaying the capture preparation notification.

In embodiments, the method may further include capturing the first image for a third time period contemporaneous with the displaying the capture notification, the capturing being performed using an image sensor of the first user terminal, the first time period being longer than the third time period by a first time amount or more.

In embodiments, a time point at which the third time period ends is the same as or earlier than a time point at which the first time period ends.

In embodiments, the method may further include measuring a data communication delay between the first user terminal and the second user terminal to obtain a measured communication delay, and determining a time point for displaying the capture preparation notification on the display based on the measured communication delay, wherein the first image and the second image are captured contemporaneously on the first user terminal and the second user terminal based on the measured communication delay.

In embodiments, the method may further include displaying a plurality of photo themes on the display based on the entering the multi-party photo capturing mode, receiving a first user input from the first user selecting a first photo theme from among the plurality of photo themes, displaying, on the display, a first image sequence captured by an image sensor of the first user terminal in a first area of the first photo theme, displaying, on the display, a second image sequence received from the second user terminal in a second area of the first photo theme, and receiving a second user input from the first user selecting a multi-party photo capturing button.

In embodiments, the displaying the plurality of photo themes may include displaying a visual object near a second photo theme to which the second user provided feedback, the second photo theme being among the plurality of photo themes.

In embodiments, the method may further include displaying a first pose guide overlaid on the first image sequence in the first area, and displaying a second pose guide overlaid on the second image sequence in the second area.

In embodiments, the composite image may include a plurality of layers, and a third image may be in an upper layer among the plurality of layers, the third image being one of the first image based on the first user terminal entering the multi-party photo capturing mode before the second user terminal, or the second image based on the second user terminal entering the multi-party photo capturing mode before the first user terminal.

In embodiments, the method may further include displaying a first image sequence in a first area of the display in response to determining that a number of users participating in the multi-party photo capturing mode is less than or equal to a first number, the displaying the first image sequence being performed based on the entering the multi-party photo capturing mode, and the first image sequence being captured by an image sensor of the first user terminal; and displaying a second image sequence in a second area of the display, the second image sequence being received from the second user terminal.

In embodiments, the method may further include displaying a first image sequence in a first area of the display in response to determining that a number of users participating in the multi-party photo capturing mode is greater than a first number, the displaying the first image sequence being performed based on the entering the multi-party photo capturing mode, and the first image sequence being received from the second user terminal, wherein a second image sequence captured by an image sensor of the first user terminal is not displayed on the display in response to determining that the number of users participating in the multi-party photo capturing mode is greater than the first number.

In embodiments, the method may further include displaying the second image sequence in a second area of the display in response to determining that a user participating in the multi-party photo capturing mode has exited and that the number of users participating in the multi-party photo capturing mode is less than or equal to the first number.

In embodiments, the method may further include transmitting the composite image to the second user terminal via the chat room.

In embodiments, the transmitting may be performed in response to receiving a user input from the first user selecting a multi-party photo capturing mode exit button.

In embodiments, a computer-readable non-transitory recording medium on which are recorded instructions that, when executed by a computer, cause the computer to perform the method according to claim 1.

In embodiments, a first user terminal includes a display, a memory, and at least one processor connected to the memory and configured to execute at least one computer-readable program included in the memory to cause the first user terminal to initiate a video call between the first user terminal and a second user terminal, the first user terminal being associated with a first user, the second user terminal being associated with a second user, and the first user and the second user being included in a chat room of an instant messaging application, enter a multi-party photo capturing mode during the video call, display a capture notification on the display for a first time period, and display, on the display, a composite image in which a first image and a second image are combined, the first image including the first user, and the second image including the second user.

In embodiments of the present disclosure, a composite image of users participating in a video call captured at the same time point (or contemporaneously) may be provided.

In embodiments of the present disclosure, an image to which various photo themes are applied may be provided.

In embodiments of the present disclosure, by inducing a user to maintain a shooting pose for a time during which a capture notification longer than the actual capture time is displayed, it is possible to prevent (or reduce the occurrence of) a composite image being captured with an unintended appearance or pose of the user due to a communication delay between user terminals.

In embodiments of the present disclosure, even if a plurality of users capture images in different environments, an image may be generated as if they were taking a picture in one space.

In embodiments of the present disclosure, a host may check the number of feedback indications (or messages) given by guest(s) to a photo theme through the host terminal, so the guest's opinion may be reflected when selecting a photo theme to apply to a photobooth image.

In embodiments of the present disclosure, users' poses may not be misaligned even if their photo capturing timings differ slightly because the users take poses according to a pose guide displayed on a display.

The effects of the present disclosure are not limited to the effects mentioned above, and other unmentioned effects will be clearly understood by a person of ordinary skill in the art to which the present disclosure pertains (hereinafter, ‘a person of ordinary skill in the art’) from the description of the claims.

### BRIEF DESCRIPTION OF THE DRAWINGS

Embodiments of the present disclosure will be described with reference to the accompanying drawings described below, wherein like reference numerals denote like elements, but are not limited thereto.

FIG. 1 is a diagram illustrating an example in which a photobooth image including a plurality of users is displayed on a display according to embodiments of the present disclosure.

FIG. 2 is a schematic diagram illustrating a configuration in which an information processing system is communicably connected with a plurality of user terminals to provide an image capturing service during a video call according to embodiments of the present disclosure.

FIG. 3 is a block diagram illustrating internal configurations of a user terminal and an information processing system according to embodiments of the present disclosure.

FIG. 4 is a block diagram illustrating an internal configuration of a processor of a user terminal according to embodiments of the present disclosure.

FIG. 5 is a diagram illustrating an operation of entering a multi-party photo capturing mode on a host terminal side according to embodiments of the present disclosure.

FIG. 6 is a diagram illustrating an operation of entering a multi-party photo capturing mode on a guest terminal side according to embodiments of the present disclosure.

FIG. 7 is a diagram illustrating an example in which a capture preparation notification and a capture notification are displayed according to embodiments of the present disclosure.

FIG. 8 is a diagram illustrating an example in which a guest provides feedback on a photo theme according to embodiments of the present disclosure.

FIG. 9 is a diagram illustrating an example in which a composite image is displayed according to embodiments of the present disclosure.

FIG. 10 is a diagram illustrating an example in which a photobooth image is displayed according to embodiments of the present disclosure.

FIG. 11 is a diagram illustrating an example of entering a photo capturing viewing mode according to embodiments of the present disclosure.

FIG. 12 is a flowchart showing a process until a composite image is generated according to embodiments of the present disclosure.

FIG. 13 is a flowchart illustrating a method for capturing an image during a video call according to embodiments of the present disclosure.

FIG. 14 is a diagram illustrating an example in which a visual object including a stamp or user information is displayed on a composite image according to embodiments of the present disclosure.

### DETAILED DESCRIPTION

Hereinafter, specific details for carrying out the present disclosure will be described in detail with reference to the accompanying drawings. However, in the following description, detailed descriptions of well-known functions or configurations will be omitted if it is determined that they may unnecessarily obscure the gist of the present disclosure.

In the accompanying drawings, the same (or similar) or corresponding components are given the same reference numerals (or similar reference numerals). In addition, in the description of the following examples, a repeated description of the same (or similar) or corresponding components may be omitted. However, even if a description of a component is omitted, it is not intended that such a component is not included in any example.

The advantages and features of the disclosed examples, and the methods for achieving them, will become clear with reference to the examples described below in conjunction with the accompanying drawings. However, the present disclosure is not limited to the examples disclosed below, but may be implemented in various different forms, and these examples are provided only to make the present disclosure complete and to fully inform a person of ordinary skill in the art of the scope of the inventive concepts.

The terms used in this specification will be briefly described, and the disclosed examples will be described in detail. The terms used in this specification have been selected from general terms that are currently widely used in consideration of the functions in the present disclosure, but this may vary depending on the intention of a technician engaged in the relevant field, precedents, the emergence of new technologies, and the like. In addition, in specific cases, there are terms arbitrarily selected by the applicant, in which case the meaning thereof will be described in detail in the description part of the corresponding inventive concepts. Therefore, the terms used in the present disclosure should be defined based on the meaning of the terms and the content throughout the present disclosure, not just the names of the terms.

The singular form of terms in this specification includes the plural form unless the context clearly dictates otherwise. In addition, the plural form includes the singular form unless the context clearly dictates otherwise. Throughout the specification, when a part is said to include a certain component, it means that it may further include other components, not excluding other components, unless there is a specific statement to the contrary.

In addition, the term ‘module’ or ‘unit’ used in the specification means a software or hardware component, and the ‘module’ or ‘unit’ performs certain roles. However, the ‘module’ or ‘unit’ is not limited to software or hardware. A ‘module’ or ‘unit’ may be configured to be in an addressable non-transitory storage medium and may be configured to reproduce one or more processors. Accordingly, as an example, a ‘module’ or ‘unit’ may include components such as software components, object-oriented software components, class components, and task components, and at least one of processes, functions, attributes, procedures, subroutines, segments of program code, drivers, firmware, microcode, circuits, data, databases, data structures, tables, arrays, or variables. The functions provided in the components and ‘modules’ or ‘units’ may be combined into a smaller number of components and ‘modules’ or ‘units’ or may be further separated into additional components and ‘modules’ or ‘units’.

According to embodiments of the present disclosure, a ‘module’ or ‘unit’ may be implemented as a processor and a memory. A ‘processor’ should be broadly interpreted to include a general-purpose processor, a central processing unit (CPU), a microprocessor, a digital signal processor (DSP), a controller, a microcontroller, a state machine, and the like. In some circumstances, a ‘processor’ may also refer to an application-specific integrated circuit (ASIC), a programmable logic device (PLD), a field-programmable gate array (FPGA), and the like. A ‘processor’ may also refer to a combination of processing devices, for example, a combination of a DSP and a microprocessor, a combination of a plurality of microprocessors, a combination of one or more microprocessors combined with a DSP core, or any other such combination. In addition, a ‘memory’ should be broadly interpreted to include any electronic component capable of storing electronic information. A ‘memory’ may also refer to various types of processor-readable media such as random access memory (RAM), read-only memory (ROM), non-volatile random access memory (NVRAM), programmable read-only memory (PROM), erasable-programmable read-only memory (EPROM), electrically erasable PROM (EEPROM), flash memory, magnetic or optical data storage, registers, and the like. A memory is said to be in electronic communication with a processor if the processor may read information from and/or write information to the memory. A memory integrated into a processor is in electronic communication with the processor.

In the present disclosure, a ‘user’ may refer to a user of an instant messaging application included in a chat room of the instant messaging application, or may refer to a user who is conducting a video call with another user in the chat room. Alternatively, a ‘user’ may refer to an image on which such a user is displayed or a partial area of the image.

In the present disclosure, a ‘user account’ may represent an account created and used by a user in an instant messaging application or data related thereto. In addition, a user account of an instant messaging application may refer to a user using the instant messaging application. Similarly, a user using instant messaging or a chat room where instant messaging is possible may refer to a user account of the instant messaging application.

In the present disclosure, a ‘chat room’ may refer to a virtual space or group in which one or more users (or user accounts) may participate, which may be created in an instant messaging application installed on a computing device. For example, one or more user accounts may participate in or be included in a chat room to exchange messages, files, etc., of various forms with each other. In addition, a Voice over Internet Protocol (VOIP) voice call function, a VoIP video call function, a live broadcast function (VOIP real-time video transmission function), and a multimedia content creation function are provided in the chat room, so that voice calls, video calls, video streaming, multimedia content transmission, etc., between user accounts may be performed.

In the present disclosure, a ‘host’ may refer to a user who has requested a multi-party photo capture among users who are in a video call, or a user who has been handed over host authority from an existing host.

In the present disclosure, a ‘guest’ may refer to a user who has accepted a host's multi-party photo capture request and entered a multi-party photo capturing mode.

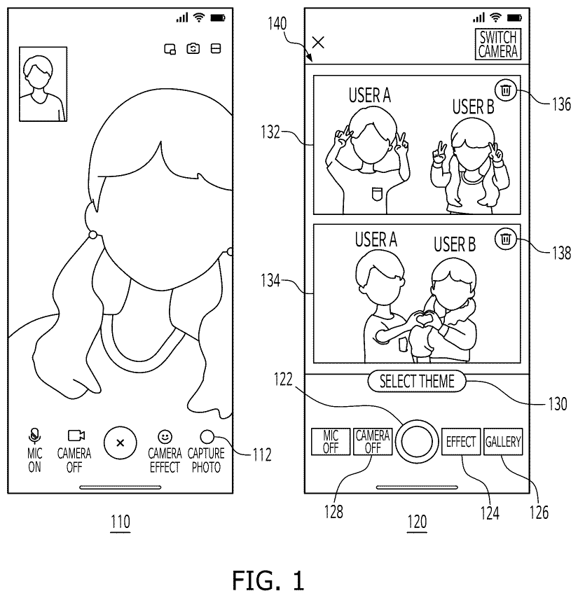

FIG. 1 is a diagram illustrating an example in which a photobooth image 140 including a plurality of users is displayed on a display according to embodiments of the present disclosure. A first operation 110 may represent a video call screen between a plurality of user terminals. On each of the plurality of user terminals, a screen including each user may be displayed at an arbitrary position and in an arbitrary size on the display, and the video call screen may not be displayed identically on all user terminals. In embodiments, a video call may be initiated and proceed between a plurality of user terminals associated with a plurality of users included in a chat room of an instant messaging application.

Although FIG. 1 illustrates that two users are conducting a video call, the present disclosure is not limited thereto, and any number of users (e.g., 6 users), who are at least a part of the users included in a chat room of an instant messaging application (e.g., 8 users), may conduct a video call (e.g., a single video call between 6 users) simultaneously (or contemporaneously).

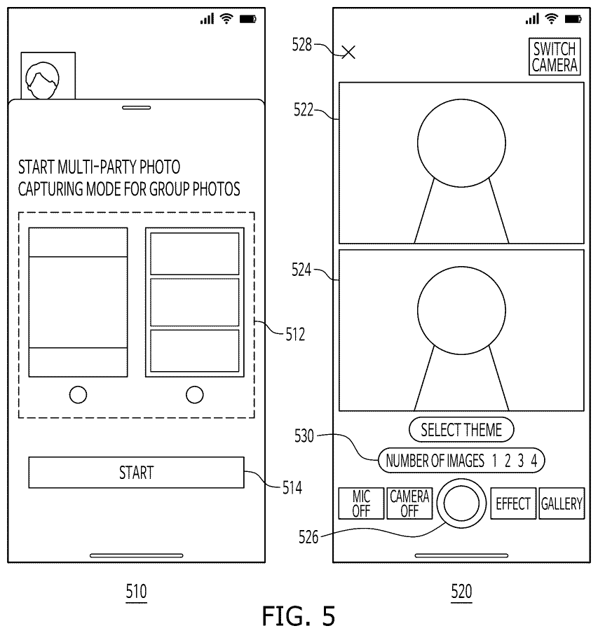

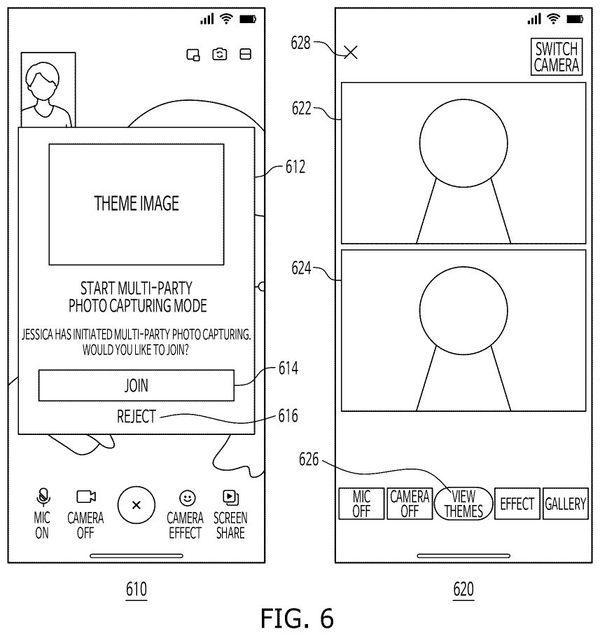

In the first operation 110, one of a plurality of users conducting a video call may enter a multi-party photo capturing mode by selecting a multi-party photo capturing mode entry button 112 with a touch input or the like. Thereafter, a multi-party photo capturing request may be transmitted to other users in the video call. Other users in the video call may enter the multi-party photo capturing mode by agreeing to the multi-party photo capturing request. A specific process of entering the multi-party photo capturing mode will be described in detail later with reference to FIG. 5 and FIG. 6.

A second operation 120 may represent an example in which a photobooth image 140 including a plurality of users is displayed on a display after a plurality of user terminals enter a multi-party photo capturing mode. At this time, the photobooth image 140 may include composite images 132 and 134 generated by combining images including each of the plurality of users.

Although FIG. 1 illustrates that the photobooth image 140 includes two composite images 132 and 134, the present disclosure is not limited thereto, and any number of composite images may be included in the photobooth image 140 at any position and in any size. For example, a user may set the number of composite images to be captured, the position and size of each of the composite images, and a composite image may be generated by capturing an image of each user a number of times corresponding to the set number of composite images.

In embodiments, a user (host) who selected the multi-party photo capturing mode entry button 112 in the first operation 110 may select a multi-party photo capturing button 122 to generate the composite images 132 and 134, which may be displayed on the display. For example, after a user selects the multi-party photo capturing button 122 to generate a first composite image 132, the user may select the multi-party photo capturing button 122 again to generate and display a second composite image 134. In another example, after a user selects the multi-party photo capturing button 122 to generate the first composite image 132, the second composite image 134 may be sequentially generated after a predetermined (or alternatively, given) time (e.g., 5 seconds) has elapsed. This process may be repeated until a predetermined (or alternatively, given) number of composite images are generated, or until the user stops taking pictures.

The multi-party photo capturing button 122 may be activated only on the user terminal of the user (host) who selected the multi-party photo capturing mode entry button 112 in the first operation 110, or may be displayed only on the corresponding user terminal (e.g., a user terminal of at least one other user in the video call). Additionally, the multi-party photo capturing button 122 may be deactivated when another user selects a camera-off button 128 to turn off the camera.

In embodiments, a user may select an effect button 124 to apply various visual effects to the composite images 132 and 134. Specifically, when the user selects the effect button 124, a list of effects applicable to the composite images 132 and 134 is displayed on the display, and when the user selects one or more effects from the effect list, the selected effects may be applied to the composite images 132 and 134. For example, it may be confirmed that an effect for displaying user information (user ID, chat name, nickname, etc., of each user in the instant messaging application, such as user A, user B, etc.) is applied to each of the composite images 132 and 134 of FIG. 1.

At this time, the effects applicable to the composite images 132 and 134 may include, but are not limited to, decorative elements (e.g., flower pictures, firework effects, etc.), information elements (e.g., information of each user included in the composite image, shooting date and time, text, etc.), and image attribute elements (e.g., brightness, saturation, etc., of the composite image).

After one or more effects are selected, the user may move the applied effect to a desired position by drag & drop or the like, or apply it to a desired size using a gesture such as spread or pinch.

In embodiments, a user may select a gallery button 126 associated with a captured image. When the user selects the gallery button 126, the user may check (e.g., view) images stored in the user terminal (e.g., previously captured composite images, photobooth images, etc.). In addition, the user may select an image stored in the user terminal and add it to the photobooth image 140.

In embodiments, a user may select a theme button 130 associated with a theme to be applied to the photobooth image 140. For example, when the user selects the theme button 130, a list of themes applicable to the photobooth image 140 is displayed on the display, and when the user selects one theme from the theme list, the photobooth image 140 to which the selected theme is applied may be displayed on the display. Alternatively, a separate theme may be selected and applied to each of the composite images 132 and 134. Additionally or alternatively, the user may select a theme in advance before the multi-party photo capturing button 122 is selected.

In embodiments, a user may delete one or both of the composite images 132 and 134 from the photobooth image 140 by selecting delete buttons 136 and 138 corresponding to each of the composite images 132 and 134, respectively. After at least a part of the composite images 132 and 134 is deleted, the user may newly generate a composite image to replace the deleted composite image.

In embodiments, the delete buttons 136 and 138 may be activated only on the user terminal of the user (host) who selected the multi-party photo capturing mode entry button 112 in the first operation 110, or may be displayed only on the corresponding user terminal (e.g., a user terminal of at least one other user in the video call). Alternatively, the delete buttons 136 and 138 may be activated for all users who have entered the multi-party photo capturing mode, but the corresponding composite image may be deleted from the photobooth image 140 only when a majority of all users select the delete button for the same composite image (or similar composite images).

The size or position of images, buttons, etc., illustrated and described in FIG. 1 are examples and are not limited thereto. For example, some buttons may be added or omitted, or may be configured with different sizes and positions from those shown.

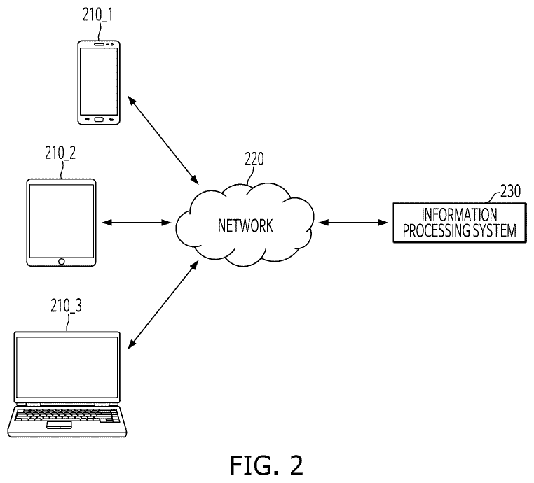

FIG. 2 is a schematic diagram illustrating a configuration in which an information processing system 230 is communicably connected with a plurality of user terminals 210_1, 210_2, and 210_3 to provide an image capturing service during a video call according to embodiments of the present disclosure. The information processing system 230 may include a system(s) that may provide an instant messaging service, a system(s) that may provide a social network service, and/or a system(s) that may provide an image capturing service during a video call. In embodiments, the information processing system 230 may include one or more server devices and/or databases, or one or more distributed computing devices and/or distributed databases based on a cloud computing service, which may store, provide, and execute computer-executable programs (e.g., downloadable applications) and data related to an instant messaging service, a social network service, and/or an image capturing service during a video call. For example, the information processing system 230 may include separate systems (e.g., servers) for the instant messaging service, the social network service, and/or the image capturing service during a video call.

An instant messaging service, an image capturing service during a video call, etc., provided by the information processing system 230 may be provided to a user through an instant messaging application or the like installed on each of the plurality of user terminals 210_1, 210_2, and 210_3. For example, the instant messaging service may include a text messaging service, a voice messaging service, a video call service, a voice call service, a video streaming service, a social network service, an image capturing service during a video call, etc., between users of the instant messaging application.

The plurality of user terminals 210_1, 210_2, and 210_3 may communicate with the information processing system 230 via a network 220. The network 220 may be configured to enable communication between the plurality of user terminals 210_1, 210_2, 210_3 and the information processing system 230. The network 220 may be configured as a wired network such as Ethernet, Power Line Communication, a telephone line communication device, and/or recommended standard (RS)-serial communication, a wireless network such as a mobile communication network, a Wireless LAN (WLAN), Wi-Fi, Bluetooth, and/or ZigBee, or a combination thereof, depending on the installation environment. The communication method is not limited, and may include not only a communication method utilizing a communication network that the network 220 may include (for example, a mobile communication network, a wired Internet, a wireless Internet, a broadcasting network, a satellite network, etc.) but also near-field wireless communication between the user terminals 210_1, 210_2, and 210_3.

In FIG. 2, a mobile phone terminal 210_1, a tablet terminal 210_2, and a PC terminal 210_3 are shown as examples of user terminals, but the present disclosure is not limited thereto, and the user terminals 210_1, 210_2, and 210_3 may be any computing device capable of wired and/or wireless communication and on which an instant messaging application or the like may be installed and executed. For example, a user terminal may include a smartphone, a mobile phone, a navigation device, a computer, a laptop, a digital broadcasting terminal, a Personal Digital Assistant (PDA), a Portable Multimedia Player (PMP), a tablet personal computer (PC), a game console, a wearable device, an Internet of Things (IoT) device, a virtual reality (VR) device, an augmented reality (AR) device, and the like. In addition, although FIG. 2 shows three user terminals 210_1, 210_2, and 210_3 communicating with the information processing system 230 via the network 220, the present disclosure is not limited thereto, and a different number of user terminals may be configured to communicate with the information processing system 230 via the network 220.

In embodiments, each of the user terminals 210_1, 210_2, and 210_3 may receive information or data from another user terminal, or transmit data to another user terminal, via the network 220. For example, each of the user terminals 210_1, 210_2, and 210_3 may transmit and receive a user input selecting a multi-party photo capturing button, a user input selecting a multi-party photo capturing mode exit button, an image including a user, a user input selecting one of a plurality of photo themes, and/or an image sequence.

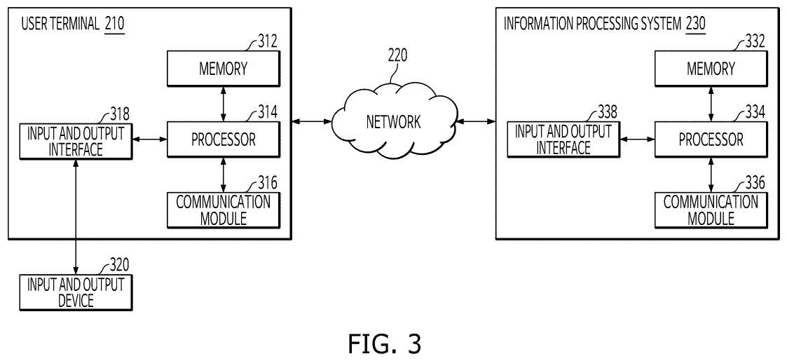

FIG. 3 is a block diagram illustrating internal configurations of a user terminal 210 and an information processing system 230 according to embodiments of the present disclosure. The user terminal 210 may refer to any computing device capable of executing an instant messaging application, or the like, and capable of wired and/or wireless communication, and may include, for example, the mobile phone terminal 210_1, the tablet terminal 210_2, the PC terminal 210_3, etc., of FIG. 2. As shown, the user terminal 210 may include a memory 312, a processor 314, a communication module 316, and/or an input/output interface 318. Similarly, the information processing system 230 may include a memory 332, a processor 334, a communication module 336, and/or an input/output interface 338. As shown in FIG. 3, the user terminal 210 and the information processing system 230 may be configured to communicate information and/or data with each other via the network 220 using their respective communication modules 316 and 336. In addition, an input/output device 320 may be configured to input information and/or data to the user terminal 210 or output information and/or data generated from the user terminal 210 via the input/output interface 318.

The memories 312 and 332 may include any non-transitory computer-readable recording medium. According to embodiments, the memories 312 and 332 may include a permanent mass storage device such as a read only memory (ROM), a disk drive, a solid state drive (SSD), a flash memory, and the like. As another example, a non-volatile mass storage device such as a ROM, an SSD, a flash memory, a disk drive, etc., may be included in the user terminal 210 or the information processing system 230 as a separate permanent storage device distinct from the memory. In addition, an operating system and at least one program code (e.g., code for an application related to an instant messaging service, a social network service, or an image capturing service during a video call) may be stored in the memories 312 and 332.

These software components may be loaded from a computer-readable recording medium separate from the memories 312 and 332. Such a separate computer-readable recording medium may include a recording medium directly connectable to the user terminal 210 and the information processing system 230, and may include, for example, a computer-readable recording medium such as a floppy drive, a disk, a tape, a DVD/CD-ROM drive, a memory card, and the like. As another example, the software components may be loaded into the memories 312 and 332 through the communication modules 316 and 336, not a computer-readable recording medium. For example, at least one program may be loaded into the memories 312 and 332 based on a computer program (e.g., an application related to an instant messaging service, a social network service, or an image capturing service during a video call, etc.) installed by files provided through the network 220 by developers or a file distribution system that distributes installation files of the application.

The processors 314 and 334 may be configured to process instructions of a computer program by performing basic arithmetic, logic, and input/output operations. Instructions may be provided to the processors 314 and 334 by the memories 312 and 332 or the communication modules 316 and 336. For example, the processors 314 and 334 may be configured to execute received instructions according to program code stored in a recording device such as the memories 312 and 332.

The communication modules 316 and 336 may provide a configuration or function for the user terminal 210 and the information processing system 230 to communicate with each other via the network 220, and may provide a configuration or function for the user terminal 210 and/or the information processing system 230 to communicate with another user terminal or another system (for example, a separate cloud system, etc.). For example, a request or data (e.g., a multi-party photo capturing request, etc.) generated by the processor 314 of the user terminal 210 according to program code stored in a recording device such as the memory 312 may be transmitted to the information processing system 230 via the network 220 under the control of the communication module 316. Conversely, a control signal or command provided under the control of the processor 334 of the information processing system 230 may be received by the user terminal 210 through the communication module 316 of the user terminal 210 via the communication module 336 and the network 220. For example, the user terminal 210 may receive an image including another user from the information processing system 230.

The input/output interface 318 may be a means for interfacing with the input/output device 320. The input/output device 320 may include an input device and/or an output device. As an example, the input device may include a device such as a camera including an audio sensor and/or an image sensor, a keyboard, a microphone, a mouse, and the like, and the output device may include a device such as a display, a speaker, a haptic feedback device, and the like. As another example, the input/output interface 318 may be a means for interfacing with a device in which a configuration or function for performing input and output is integrated into one, such as a touchscreen. Although FIG. 3 shows that the input/output device 320 is not included in the user terminal 210, the present disclosure is not limited thereto, and it may be configured as one device with the user terminal 210. In addition, the input/output interface 338 of the information processing system 230 may be a means for interfacing with a device (not shown) for input or output that is connected to or may be included in the information processing system 230. Although FIG. 3 shows the input/output interfaces 318 and 338 as elements configured separately from the processors 314 and 334, the present disclosure is not limited thereto, and the input/output interfaces 318 and 338 may be configured to be included in the processors 314 and 334.

The user terminal 210 and the information processing system 230 may include more components than the components of FIG. 3. However, it is not necessary to clearly show most conventional technical components. In embodiments, the user terminal 210 may be implemented to include at least a part of the above-described input/output device 320. In addition, the user terminal 210 may further include other components such as a transceiver, a Global Positioning System (GPS) module (e.g., a GPS receiver), a camera, various sensors, a database, and the like. For example, if the user terminal 210 is a smartphone, it may include components generally included in a smartphone, and for example, various components such as an acceleration sensor, a gyro sensor, a microphone module (e.g., a microphone), a camera module (e.g., a camera), various physical buttons, buttons using a touch panel, input/output ports, a vibrator for vibration, etc., may be further implemented in the user terminal 210.

According to embodiments, the processor 314 of the user terminal 210 may be configured to operate an instant messaging application or a web browser application that provides an instant messaging service including an image capturing service during a video call. At this time, program code associated with the corresponding application may be loaded into the memory 312 of the user terminal 210. While the application is operating, the processor 314 of the user terminal 210 may receive information and/or data provided from the input/output device 320 via the input/output interface 318 or receive information and/or data from the information processing system 230 via the communication module 316, and may process the received information and/or data and store it in the memory 312. In addition, such information and/or data may be provided to the information processing system 230 via the communication module 316.

While the instant messaging application is operating, the processor 314 may receive voice data, text, images, videos, etc., input or selected through an input device such as a touch screen, a keyboard, a camera including an audio sensor and/or an image sensor, and a microphone connected to the input/output interface 318, and may store the received voice data, text, images, and/or videos in the memory 312 or provide them to the information processing system 230 via the communication module 316 and the network 220. In embodiments, the processor 314 may receive a user input selecting a graphic object displayed on the display, which is input through the input device, and may provide data/a request corresponding to the received user input to the information processing system 230 via the network 220 and the communication module 316.

The processor 314 of the user terminal 210 may transmit information and/or data to the input/output device 320 via the input/output interface 318 to be output. For example, the processor 314 of the user terminal 210 may output processed information and/or data through an output device 320 such as a display-output-capable device (e.g., a touch screen, a display, etc.) and a voice-output-capable device (e.g., a speaker). In embodiments, the processor 314 may display a composite image, in which images including each of a plurality of users are combined, on the display of the user terminal 210.

The processor 334 of the information processing system 230 may be configured to manage, process, and/or store information and/or data received from the plurality of user terminals 210 and/or a plurality of external systems. The information and/or data processed by the processor 334 may be provided to the user terminal 210 via the communication module 336 and the network 220.

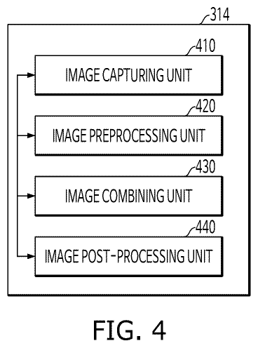

FIG. 4 is a block diagram illustrating an internal configuration of the processor 314 of a user terminal according to embodiments of the present disclosure. As shown, the processor 314 may include an image capturing unit 410, an image preprocessing unit 420, an image combining unit 430, an image post-processing unit 440, and the like.

The image capturing unit 410 may receive an image including a user (e.g., depicting a user) captured using an image sensor of the user terminal or acquire/generate a screenshot of an image including a user displayed on a display. For example, the image capturing unit 410 may receive an image including a user (host) from the image sensor in response to the user (host) selecting a multi-party photo capturing button. In addition, the image capturing unit 410 may receive an image including another user (guest) from another user terminal. In another example, the image capturing unit 410 may acquire/generate a screenshot of an image including another user displayed on the display. In yet another example, the image capturing unit 410 may receive an image including a user (guest) captured using the image sensor in response to a capture signal received from another user terminal when another user (host) selects the multi-party photo capturing button.

The image capturing unit 410 may output a capture notification from the user terminal for a first time period. For example, the image capturing unit 410 may output a message such as ‘Capturing photo, please do not move’ on the display of the user terminal or output a sound (e.g., a beep sound, etc.) indicating that photo capturing is in progress. Additionally, the image capturing unit 410 may output a capture preparation notification to the user terminal for a second time period before displaying the capture notification. For example, the image capturing unit 410 may display a timer on the display that times out upon the elapse of the second time period, or output it (e.g., a remaining amount of time on the timer) by voice. In embodiments, a time point for displaying the capture preparation notification may be determined based on a measured data communication delay between the user terminal and another user terminal. That is, the image capturing unit 410 may capture an image including the user at the same timing as (or a similar timing to) the time point at which an image including another user is captured on the other user terminal, based on the measured data communication delay between the user terminal and the other user terminal.

In embodiments, while a capture notification is displayed (or contemporaneous with the display of the capture notification) on the display of the user terminal for a first time period, the image capturing unit 410 may capture an image including the user for a third time period using the image sensor of the user terminal and receive the captured image from the image sensor. At this time, the first time period may be longer than the third time period by a predetermined (or alternatively, given) time (e.g., 1 second) or more, and a time point at which the third time period ends may be the same as (or similar to) or earlier than a time point at which the first time period ends. According to embodiments, the image sensor may include a plurality of photodetectors arranged as pixels, each respective photodetector among the photodetectors generating a signal corresponding to an amount of light incident on the respective photodetector. The incident light having previously been directed at the user from a light source (e.g., a flash, ambient light, and/or another natural or artificial light source) and reflected off of the user before being received by the plurality of photodetectors. The image capturing unit 410 may receive the signals generated by the photodetectors and generate an image depicting the user based on the signals. For example, the generated image may include a plurality of pixels where a value of each respective pixel corresponds to a signal output by a corresponding photodetector.

Through this configuration, by inducing a user to maintain a shooting pose for a time during which a capture notification longer than the actual capture time is displayed, it is possible to prevent a composite image being captured with an unintended appearance or pose of the user (or reduce the occurrence thereof) due to a communication delay between user terminals.

The image preprocessing unit 420 may preprocess an image captured by the image capturing unit 410, an image acquired through a screenshot, and/or an image received from another user terminal. In embodiments, the image preprocessing unit 420 may determine an outline of a user included in a user image captured by the image capturing unit 410, and may separate a background image from the user based on the determined outline. According to embodiments, the captured image may include (e.g., be represented by) a plurality of pixels and the determination of the outline of the user may include determining a first subset of the pixels representing the outline. According to embodiments, the image capturing unit 410 may determine a second subset of the pixels representing the background, and/or a third subset of the pixels representing the user, based on the first subset of the pixels (e.g., the outline). For example, the image capturing unit 410 may determine the second subset of the pixels outside of the outline as representing the background, and/or a third subset of the pixels inside the outline as representing the user. Through this configuration, by generating a composite image based on an image from which background elements have been removed, an image may be generated as if a plurality of users were taking a picture in one space. According to embodiments, references to preprocessing made herein may also refer to processing without any time-based restriction.

In embodiments, the image preprocessing unit 420 may normalize attributes of color (e.g., including brightness and/or saturation) that represent hue to the intensity of color, contrast, and shading of an image captured by the image capturing unit 410, an image acquired through a screenshot, and/or an image of another user received from another user terminal. Through this configuration, even if a plurality of users capture images in different environments, an image may be generated as if they were taking a picture in one space.

In embodiments, the image preprocessing unit 420 may resize an image including each of a plurality of users so that the sizes of the plurality of users are displayed similarly in a composite image, or may rotate the image so that the plurality of users are displayed in the same/similar direction.

The image combining unit 430 may generate a composite image by combining images including each of a plurality of users. For example, the image combining unit 430 may generate a composite image by combining an image including a user (host) and an image including another user (guest). In embodiments, the image including the other user (guest) may be one received from the other user's terminal. Alternatively or additionally, the image including the other user (guest) may correspond to a screenshot acquired on the user's (host's) terminal. According to embodiments, the image combining unit 430 may generate the composite image by replacing pixel values of a background image (e.g., a blank image) with corresponding pixel values of the user (host) and other user (guest), for example, the third subset of the pixels and/or the first subset of the pixels.

The image combining unit 430 may generate a composite image including a plurality of layers such that an image captured at a user terminal that first entered a multi-party photo capturing mode among a plurality of user terminals is arranged in an upper layer. For example, a host terminal enters the multi-party photo capturing mode together with a multi-party photo capturing request, so an image including the host may be arranged in the uppermost layer. In another example, the image combining unit 430 may change the arrangement of layers according to a host's request to change the position of a layer, or may arrange layers according to a layer setting rule preset (or set) by the host.

The image post-processing unit 440 may apply a theme and/or effect selected by a user to a composite image. Alternatively, a configuration for applying a theme and/or effect selected by a user to a composite image may be performed in the image combining unit 430. For example, an operation of applying a background or a theme to a composite image may be performed by arranging the corresponding background image in the lowermost layer. In another example, an operation of displaying an effect on a composite image may be performed by arranging the corresponding effect image in the uppermost layer. According to embodiments, references to post-processing made herein may also refer to processing without any time-based restriction.

The internal configuration of the processor 314 shown in FIG. 4 is merely an example, and in embodiments, other configurations may be additionally included in addition to the shown internal configuration, and/or some configurations may be omitted. For example, if some of the above internal configurations are omitted, the processor 334 of the information processing system and/or another user terminal may be configured to perform the functions of the omitted internal configurations. For instance, the processor 334 of the information processing system and/or another user terminal may perform an image preprocessing task. In addition, although the internal configuration of the processor 314 in FIG. 4 has been described by being divided by function, it does not necessarily mean that they are physically divided. The image capturing unit 410, the image preprocessing unit 420, the image combining unit 430, and the image post-processing unit 440 have been described separately, but this is for the purpose of helping to understand the present disclosure and is not limited thereto.

FIG. 5 is a diagram illustrating an operation of entering a multi-party photo capturing mode on a host terminal side according to embodiments of the present disclosure. A first operation 510 shows an example in which a user selects a multi-party photo capturing mode entry button on a host terminal during a video call, so that an area 512 where an attribute of a photobooth image to be captured may be selected and a button 514 for entering the multi-party photo capturing mode are displayed on the display of the host terminal. Although FIG. 5 illustrates selecting the number of composite images to be included in the photobooth image in the area 512, the present disclosure is not limited thereto. For example, the host may preset (or set) the position, size, theme, etc., of each composite image in the area 512.

A second operation 520 shows an example of entering a multi-party photo capturing mode in response to receiving a user input selecting a button 514 on a host terminal. As shown, a first image sequence captured by an image sensor of the host terminal may be displayed in a first area 522 of the display. In addition, a second image sequence received from a guest terminal may be displayed in a second area 524 of the display. Here, the guest terminal may be a user terminal of another user who was conducting a video call with the host and then entered the multi-party photo capturing mode created by the host. Additionally, the host may adjust the position, size, etc., of an area where the first image sequence and the second image sequence will be displayed in the multi-party photo capturing mode.

In embodiments, a host may set and/or change the number of images to be included in a composite image in an area 530. For example, the host may select the number ‘2’ in the area 530 to set it to continuously capture two composite images. In contrast, the host may select the number ‘4’ in the area 530 to set it to continuously capture four composite images. Although the area 530 shows that the host may select one from 1 to 4, the present disclosure is not limited thereto, and the host may select any number.

In embodiments, a capture preparation notification may be displayed as a host selects a multi-party photo capturing button 526. Thereafter, a capture notification is displayed and multi-party photo capturing is executed to generate a composite image (or a photobooth image). The generated composite image may be displayed on the displays of the host terminal and the guest terminal for confirmation by the host and the guest.

In contrast, as the host selects the multi-party photo capturing button 526, video recording may start to generate a composite video (or a photobooth video). Here, the composite video (or the photobooth video) may include a plurality of composite images (or a plurality of photobooth images). At this time, the composite video may be recorded for a predetermined (or alternatively, given) time, or may be recorded for a time according to a user input (e.g., the time during which the user holds down the multi-party photo capturing button 526). The generated composite video (or photobooth video) may be saved or played at a predetermined (or alternatively, given) speed (e.g., 2× speed or 3× speed).

In embodiments, a host may select an exit button 528 before and/or after the capture of a photobooth image is completed. As the host selects the exit button 528 before the capture of the photobooth image is completed, the multi-party photo capturing mode may be terminated on the host terminal. In this case, host authority may be granted to one of the guests included in the multi-party photo capturing mode (e.g., the guest who entered the multi-party photo capturing mode next in order after the host). At this time, after the multi-party photo capturing mode is terminated on the host terminal, the delegation of host authority may be performed after a predetermined (or alternatively, given) time (e.g., 5 seconds) has elapsed, and if the host reconnects to the multi-party photo capturing mode before the predetermined (or alternatively, given) time has elapsed, the host authority may be maintained.

In contrast, if the host selects the exit button 528 after the capture of the photobooth image is completed, the photobooth image may be saved on the host terminal and transmitted to the guest terminal through a chat room where the video call was made or a 1:1 chat room with the guest.

FIG. 6 is a diagram illustrating an operation of entering a multi-party photo capturing mode on a guest terminal side according to embodiments of the present disclosure. A first operation 610 shows an example in which, as a guest terminal receives a multi-party photo capturing request from a host terminal during a video call, an area 612 for determining whether to accept the request is displayed on the display of the guest terminal.

In embodiments, attribute information of a photobooth image to be captured may be displayed in the area 612. For example, although FIG. 6 shows that information associated with a theme of the photobooth image is displayed, the present disclosure is not limited thereto, and the number, position, size, etc., of composite images may be displayed. Additionally, information such as a host of the multi-party photo capturing mode, a list of participating guests, etc., may be further displayed. A guest may select a first button 614 in the area 612 to enter the multi-party photo capturing mode, or select a second button 616 to reject the multi-party photo capture.

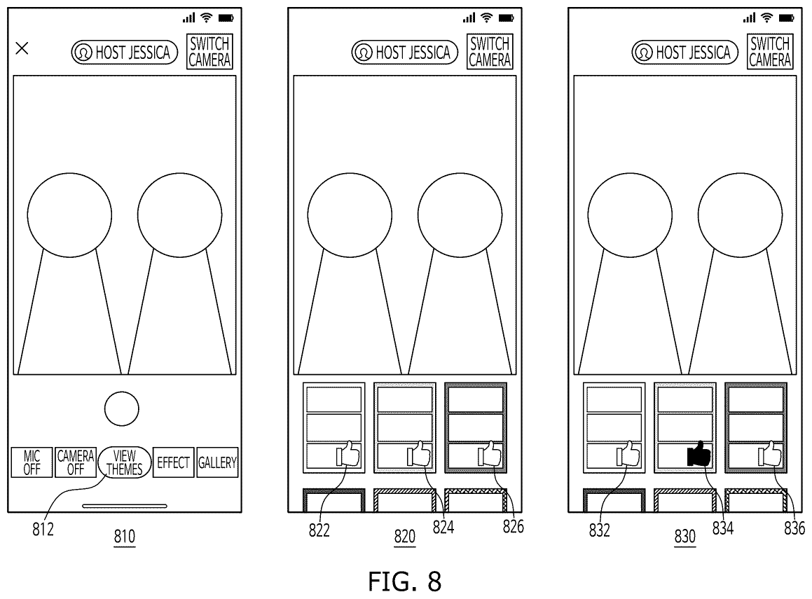

A second operation 620 shows an example in which a user selects a first button 614 on a guest terminal to enter a multi-party photo capturing mode. Unlike in FIG. 5, instead of a multi-party photo capturing button being displayed on the display of the guest terminal, a third button 626 may be displayed, with which information on a theme currently applied to a photobooth image and/or applicable themes may be checked (e.g., viewed). After selecting the third button 626, the guest may select theme information desired to be applied to the photobooth image. This will be described in detail later with reference to FIG. 8.

As shown, a first image sequence received from a host terminal may be displayed in a first area 622 of the display. In addition, a second image sequence captured by an image sensor of the guest terminal may be displayed in a second area 624 of the display.

In embodiments, a guest may exit from a multi-party photo capturing mode by selecting an exit button 628 before or after the capture of a photobooth image is completed. In this case, the multi-party photo capturing mode is terminated on the guest terminal, and a video call screen that was displayed before entering the multi-party photo capturing mode may be displayed again.

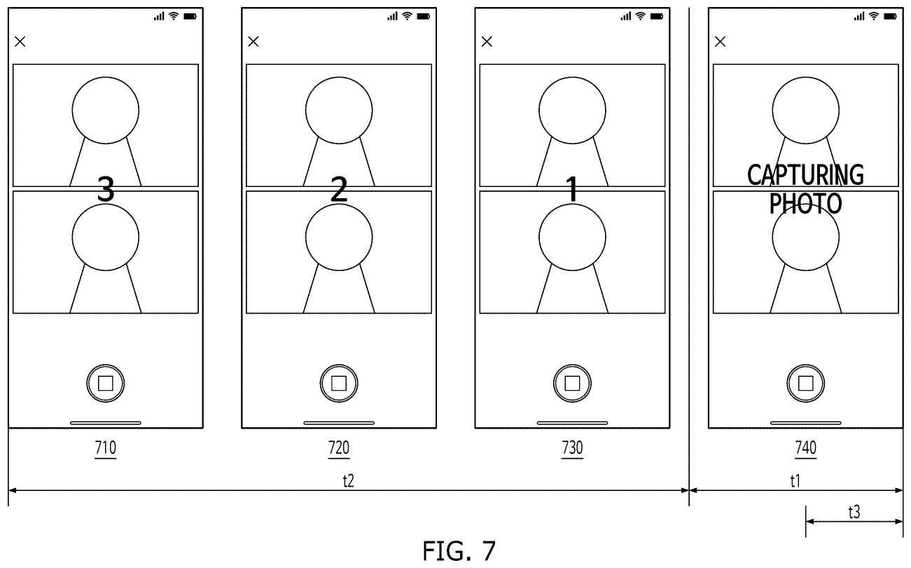

FIG. 7 is a diagram illustrating an example in which a capture preparation notification and a capture notification are displayed according to embodiments of the present disclosure. First to third operations 710, 720, and 730 show an example in which a capture preparation notification is output on a display of a user terminal for a second time period t2 in response to a host selecting a multi-party photo capturing button. For example, as shown, a timer (e.g., a countdown) that times out as the second time period t2 elapses may be displayed on the display of the user terminal. At this time, a time point at which to start displaying the capture preparation notification on each of the host terminal and the guest terminal may be determined based on a data communication delay measured between the host terminal and the guest terminal. According to embodiments, different respective time points may be determined based on the data communication delay such that the capture preparation notification is simultaneously (or contemporaneously) displayed on both the host terminal and the guest terminal. For example, the data communication delay between the information processing system 230 and the host terminal may be different from the data communication delay between the information processing system 230 and the guest terminal.

In embodiments, the operation of measuring a data communication delay and determining a time point for displaying the capture preparation notification may be managed by the information processing system 230 in communication with the first and second user terminals. For example, upon entry into the multi-party photo capturing mode, the processor 334 of the information processing system 230 may initiate a latency measurement process to synchronize the capture timing.

The information processing system 230 may transmit a timestamped data packet (e.g., a “ping” packet) to both the first user terminal 210_1 and the second user terminal 210_2. Each user terminal, upon receiving the packet, may be configured to immediately transmit a response packet (e.g., a “pong” packet) back to the information processing system 230. The processor 334 may then calculate the round-trip time (RTT) for each terminal by measuring the duration between sending the ping packet and receiving the corresponding pong packet. Half of the RTT may be used as an estimate of the one-way communication delay between the information processing system 230 and each user terminal.

Based on these individual measured delays, the processor 334 may determine a synchronization offset. For example, if the measured delay for the first user terminal is 50 ms and for the second user terminal is 80 ms, the processor 334 may calculate a delay difference of 30 ms. When the first user (host) selects the multi-party photo capturing button 526, a capture initiation signal may be sent to the information processing system 230. The system 230 may then determine the appropriate time point to start the capture preparation notification on each device. The system 230 may transmit the command to display the capture preparation notification to the second user terminal (with the 80 ms delay) first, and then transmit the same command to the first user terminal (with the 50 ms delay) after a 30 ms offset.

Consequently, both terminals may start displaying the capture preparation notification (e.g., the countdown timer shown in FIG. 7) at substantially the same time from the users' perspectives. This synchronization ensures that when the capture preparation notification period ends, the first image and the second image are captured contemporaneously on their respective terminals, minimizing discrepancies caused by network latency.

A fourth operation 740 shows an example in which a capture notification is displayed on a display of a user terminal for a first time period t1 after the capture preparation notification is output. For example, a message such as ‘Capturing photo’ may be output on the display of the user terminal. Additionally or alternatively, a guidance sound indicating that photo capturing is in progress may be output.

In embodiments, while a capture notification is displayed (or contemporaneous with the display of the capture notification) on a display of a user terminal for a first time period t1, an image including a user may be captured for a third time period t3 using an image sensor of the user terminal. At this time, the first time period t1 may be longer than the third time period t3 by a predetermined (or alternatively, given) time (e.g., 1 second) or more, and a time point at which the third time period t3 ends may be the same as (or similar to) a time point at which the first time period t1 ends. In contrast, the time point at which the third time period t3 ends may be earlier than the time point at which the first time period t1 ends. The third time period t3 during which the image is captured may vary depending on the shooting environment, the specifications of the image sensor, and the like. For example, the image may be captured 1 second after the capture notification is displayed, and the first time period t1 and the third time period t3 may end as the image capture is completed.

In embodiments, a camera-off button and a multi-party photo capturing mode exit button may be deactivated while a capture preparation notification or a capture notification is displayed (or contemporaneous with the display of the capture preparation notification or the capture notification). Additionally, a host may select a button to stop photo capturing while the capture preparation notification or the capture notification is displayed. When the host selects the button to stop photo capturing, the display of the capture preparation notification or the capture notification is stopped, and the camera-off button and the multi-party photo capturing mode exit button may be reactivated.

FIG. 8 is a diagram illustrating an example in which a guest provides feedback on a photo theme according to embodiments of the present disclosure. A first operation 810 shows an example of a screen displayed on a display of a guest terminal as the guest terminal enters a multi-party photo capturing mode.

A second operation 820 shows an example in which, after a guest terminal enters a multi-party photo capturing mode and before a capture notification is displayed, a plurality of photo themes that may be applied to a photobooth image/composite image are displayed as the guest selects a button 812 (or in response to the guest selecting the button 812). Thereafter, the guest may provide feedback (e.g., positive feedback or negative feedback, etc.) on a specific photo theme by selecting at least one of visual objects 822, 824, and 826 displayed on a preview (e.g., thumbnail) of the plurality of photo themes.

A third operation 830 shows an example in which, in response to a guest providing feedback (or, positive feedback) on a specific photo theme by selecting a visual object 824, a visual object 834 indicating the feedback (the feedback may also be referred to as a feedback indication) is displayed together near the selected photo theme. As the guest provides feedback on a specific photo theme, the visual object 834 displayed on the selected photo theme is different from other visual objects 832 and 836 that have not been given feedback, so the guest may easily check (or discern) the photo theme to which he or she has given feedback.

Additionally, a host may check the number of feedbacks (e.g., the number of feedback indications) given by guest(s) to a photo theme through the host terminal. Through this configuration, the host may reflect the guest's opinion when selecting a photo theme to apply to a photobooth image. In contrast, a photo theme with the largest number of positive feedbacks (or feedback indications) may be automatically applied to the photobooth image, or a message may be provided to the host suggesting changing to the photo theme with the largest number of positive feedbacks (or feedback indications).

After a host selects a photo theme to apply to a photobooth image, a first image sequence captured by an image sensor of the host terminal may be displayed in a first area of the selected photo theme on a display. In addition, a second image sequence captured by an image sensor of a guest terminal may be displayed in a second area of the selected photo theme on the display.

In embodiments, the operation of displaying image sequences in different areas corresponding to a selected photo theme may be implemented by using theme-specific layout templates. Each of the plurality of photo themes available for selection may be associated with a unique layout template stored in the memory 312 of the user terminal 210 or provided by the information processing system 230. A layout template may define the number, size, position, and shape of distinct areas on the display for arranging the image sequences of the participants.

For example, a user may select a “Comic Strip” photo theme from the list of photo themes. The processor 314 of the first user terminal may then retrieve the layout template associated with the “Comic Strip” theme. This template may specify that the display should be divided into three vertical rectangular areas, each with a thick black border, mimicking a comic book panel.

Upon applying this theme, the processor 314 may display the first image sequence, captured by the image sensor of the first user terminal, within the first area (e.g., the leftmost panel) of the selected “Comic Strip” theme, as recited in step 467. Simultaneously, the processor 314 may display the second image sequence, received from the second user terminal, in a second, distinct area (e.g., the middle panel), as recited in step 468. If a third user is participating, their image sequence may be displayed in the third area (e.g., the rightmost panel).

Furthermore, the layout template may also include metadata for applying specific visual effects or pose guides to each area. For instance, the “Comic Strip” theme might apply a cel-shading filter to the image sequences and overlay a “POW!” speech bubble pose guide in one area, and a “THINKING . . . ” thought bubble pose guide in another. When the user selects the multi-party photo capturing button 470, the final composite image may be generated by arranging the captured images of each user into their designated areas as defined by the “Comic Strip” layout template, resulting in a cohesive, stylized photobooth image.

In embodiments, a photo theme may include a pose guide. Here, the pose guide may be a visual guide displayed on a display so that users may easily follow a specific pose. For example, a first pose guide may be displayed overlaid on a first image sequence in a first area of a selected photo theme, and a second pose guide may be displayed overlaid on a second image sequence in a second area. Through this configuration, by inducing users to take pictures in various poses, users may capture composite images with a high-quality composition without being burdened with devising poses. In addition, because users take poses according to a pose guide displayed on a display, the users' poses may not be misaligned even if their photo capturing timings differ slightly.

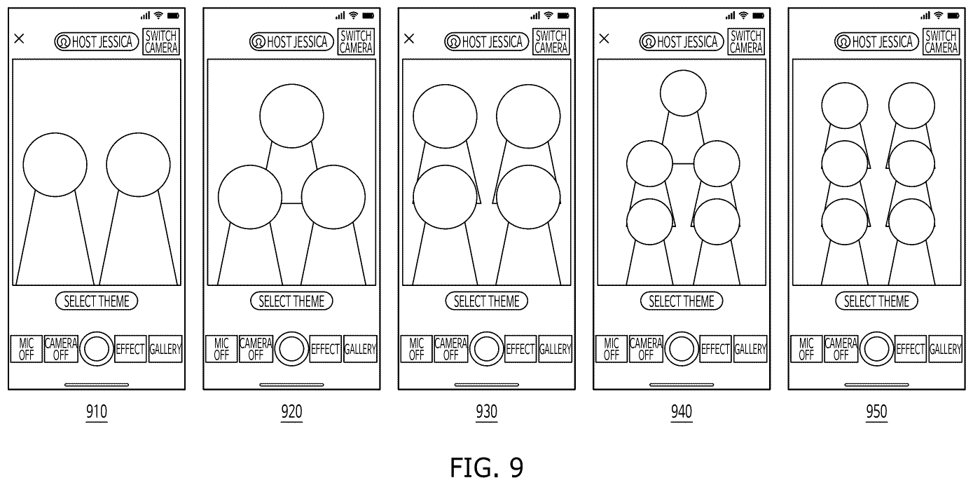

FIG. 9 is a diagram illustrating an example in which a composite image is displayed according to embodiments of the present disclosure. A plurality of users included in each of the composite images displayed in a first example to a fifth example 910, 920, 930, 940, and 950 of FIG. 9 may correspond to users who have entered a multi-party photo capturing mode. The first example to the fifth example 910, 920, 930, 940, and 950 are examples of cases where the number of users who have entered the multi-party photo capturing mode is 2-6, respectively.

In embodiments, a composite image may include a plurality of layers, and an image/image sequence of a user who first entered a multi-party photo capturing mode may be arranged in an upper layer. For example, in the case of a third example 930, users arranged at the bottom may be users who entered the multi-party photo capturing mode earlier than users arranged at the top.

A composite image may be generated by combining images including each of a plurality of users, and the relative position or size (layout) of a user within the composite image may be varied each time a user who has entered a multi-party photo capturing mode is added or removed. For example, a user located at the top of a second example 920 may be moved to the left of the existing position in a third example 930 where a user who has entered the multi-party photo capturing mode has been added. In addition, the size of an image including each user in the third example 930 may be larger than the size of an image including each user in a fourth example 940 where a user who has entered the multi-party photo capturing mode has been added.

The position or size of a user within a composite image may be determined based on a predetermined (or alternatively, given) user arrangement rule and the number of users who have entered a multi-party photo capturing mode, or may be changed based on a user input of a host changing the position or size of each user.

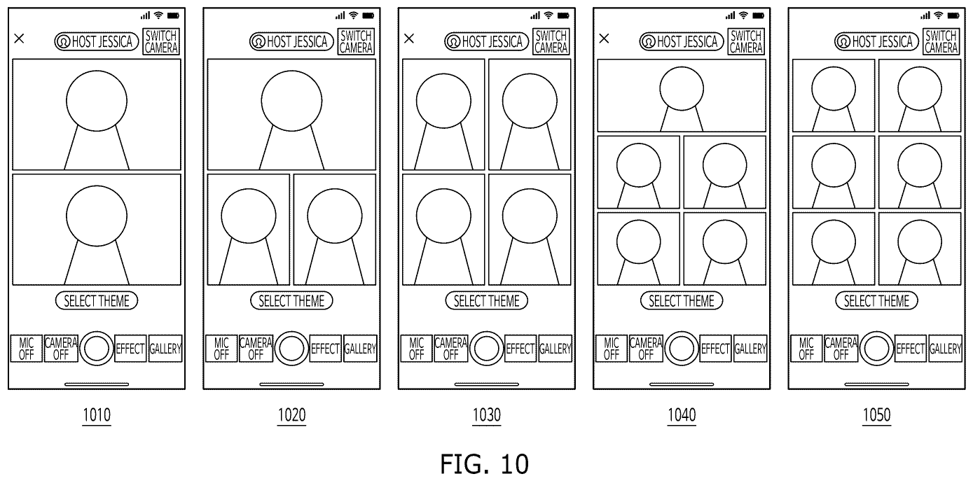

FIG. 10 is a diagram illustrating an example in which a photobooth image is displayed according to embodiments of the present disclosure. In a first example to a fifth example 1010, 1020, 1030, 1040, and 1050 of FIG. 10, a plurality of users included in each grid of a photobooth image may correspond to users who have entered a multi-party photo capturing mode. Although FIG. 10 shows that one user is included in each grid, the present disclosure is not limited thereto. The first example to the fifth example 1010, 1020, 1030, 1040, and 1050 are examples of cases where the number of users who have entered the multi-party photo capturing mode is 2-6, respectively.

A photobooth image may be generated by combining images including each of a plurality of users, and the relative position and size of a grid may be varied each time a user who has entered a multi-party photo capturing mode is added or removed. For example, it may be confirmed that the top grid in the photobooth image of a second example 1020 is moved to the left from the existing position and its size is reduced by half after a user is added in a third example 1030. The position of a user within a grid in a photobooth image may be determined based on a predetermined (or alternatively, given) arrangement rule and the number of users who have entered a multi-party photo capturing mode, or may be changed based on a user input of a host changing the position of each user within the grid.

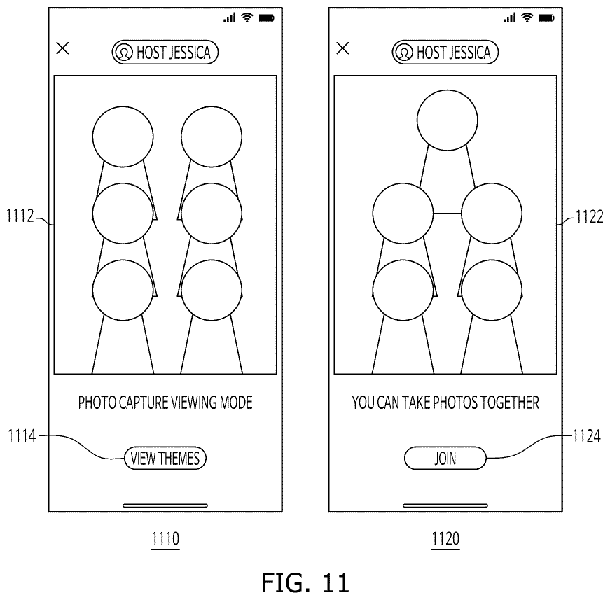

FIG. 11 is a diagram illustrating an example of entering a photo capturing viewing mode according to embodiments of the present disclosure. A first operation 1110 shows an example in which a user attempts to enter a multi-party photo capturing mode, but the number of users participating in the multi-party photo capturing mode exceeds a predetermined (or alternatively, given) number (e.g., 6 people), so the user enters a photo capturing viewing mode instead of a photo capturing mode. For example, an image sequence received from a user terminal that is already participating is displayed in an area 1112, and an image sequence captured by an image sensor of a user terminal that has entered the photo capturing viewing mode may not be displayed in the corresponding area 1112. That is, a user who has entered the photo capturing viewing mode may view the multi-party photo capturing process of other users who were in a video call, but may not participate in the multi-party photo capturing himself/herself. The predetermined (or alternatively, given) number may also be referred to herein as a threshold value.

In contrast, when a user enters a multi-party photo capturing mode, if the number of users participating in the multi-party photo capturing mode is less than or equal to the predetermined (or alternatively, given) number, the newly entered user may enter the multi-party photo capturing mode instead of the photo capturing viewing mode. In this case, a first image sequence captured by an image sensor of a user terminal that is already participating may be displayed in a first area of the display, and a second image sequence received from the newly entered user terminal may be displayed in a second area of the display. If there are three or more participating users, a third image sequence captured by an image sensor of another user terminal may be displayed in a third area of the display in a similar manner.

In embodiments, a user who has entered a photo capturing viewing mode may check a plurality of photo themes by selecting a photo theme button 1114, and may provide feedback (e.g., positive feedback or negative feedback, etc.) on some photo themes according to his/her preference (or priorities).

A second operation 1120 shows an example in which some of the users participating in a multi-party photo capturing mode exit, so that the number of participating users changes to be less than or equal to the predetermined (or alternatively, given) number. In this case, a participation button 1124 for participating in the multi-party photo capturing mode may be displayed on the display of the user terminal of the user who is viewing in the photo capturing viewing mode. The viewing user may exit the photo capturing viewing mode and enter the multi-party photo capturing mode by selecting the participation button 1124. In response to the user selecting the participation button 1124, an image sequence captured by an image sensor of the corresponding user terminal may be displayed in a partial area of an area 1122 of the display.

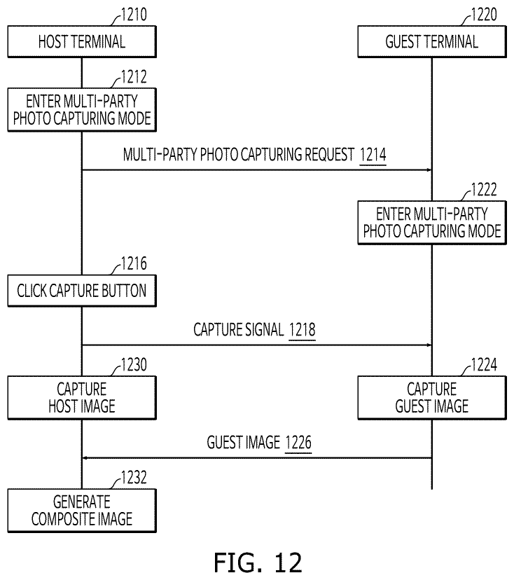

FIG. 12 is a flowchart showing a process until a composite image is generated according to embodiments of the present disclosure. After a video call is initiated between a first user terminal associated with a first user and a second user terminal associated with a second user included in a chat room of an instant messaging application, a host terminal 1210 may enter a multi-party photo capturing mode 1212. For example, the host terminal may enter the multi-party photo capturing mode by receiving a user input selecting a multi-party photo capturing mode entry button with a touch input or the like. When the host terminal 1210 enters the multi-party photo capturing mode 1212, the host terminal 1210 may transmit a multi-party photo capturing request 1214 to a guest terminal 1220. According to embodiments, each of the host terminal 1210 and the guest terminal 1220 may be implemented using the user terminal 210.

Thereafter, when the guest terminal 1220 receives a user input agreeing to the multi-party photo capturing request, the guest terminal 1220 may enter the multi-party photo capturing mode 1222.

Thereafter, the host terminal 1210 may receive a user input clicking a capture button 1216 from the user. As the host terminal 1210 receives the user input clicking the capture button, the host terminal 1210 may transmit a capture signal 1218 to the guest terminal 1220.

In response to the host terminal 1210 receiving the user input clicking the capture button, the host terminal 1210 may capture an image including the host 1230 using an image sensor. Likewise, upon receiving the capture signal from the host terminal 1210, the guest terminal 1220 may capture an image including the guest 1224 using an image sensor. In embodiments, a data communication delay time between the host terminal 1210 and the guest terminal 1220 may be measured. In this case, based on the measured data communication delay time, a time point at which an image is captured on the host terminal 1210 and a time point at which an image is captured on the guest terminal 1220 may be synchronized.

Thereafter, the host terminal 1210 may receive an image including the guest 1226 from the guest terminal 1220. In contrast, the host terminal 1210 may acquire/generate a screenshot of the image including the guest.

In embodiments, the operation of acquiring a screenshot of the second image may be performed by the processor 314 of the first user terminal (e.g., the host terminal 1210). For example, during the video call, the display of the first user terminal may be configured to present a video stream from the second user terminal (e.g., the guest terminal 1220) within a specific and identifiable area of a user interface. This area may be a window, a tile, or a designated portion of a split-screen layout.

When the first user provides a user input for multi-party photo capturing (e.g., by selecting the multi-party photo capturing button 122, 526), the processor 314 may be configured to execute a targeted screen capture operation. Instead of capturing the entire screen of the display, the processor 314 may identify the coordinates and dimensions of the specific area displaying the video stream of the second user. The processor 314 may then capture only the pixel data within this identified area at a moment contemporaneous with the displaying of the capture notification.

This captured pixel data may then be treated as the second image. The image combining unit 430 may then receive this second image, which is a screenshot of the second user's video feed, and combine it with the first image captured by the image sensor of the first user terminal. This method may be advantageous in scenarios where transmitting a separate, high-resolution image from the second user terminal is inefficient due to network bandwidth limitations. The processor 314 may thus generate the composite image 1232 by directly utilizing the video data already being streamed to the first user terminal, thereby reducing data transmission requirements between the terminals.

Thereafter, the host terminal 1210 may generate a composite image 1232 by combining the image including the host and the image including the guest.

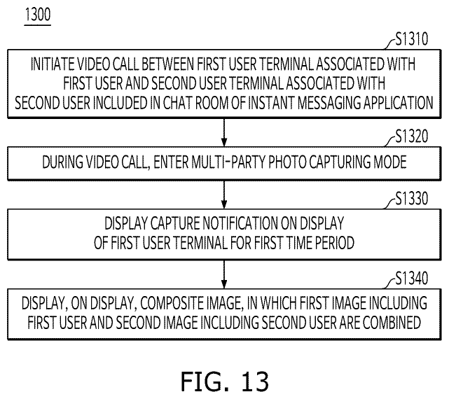

FIG. 13 is a flowchart illustrating a method for capturing an image during a video call 1300 according to embodiments of the present disclosure. The method 1300 may be performed by at least one processor of a first user terminal. In S1310, the processor may initiate a video call between a first user terminal associated with a first user and a second user terminal associated with a second user included in a chat room of an instant messaging application.

Thereafter, in S1320, the processor may enter a multi-party photo capturing mode during the video call. In embodiments, the processor may deactivate a multi-party photo capturing button in response to determining that the second user terminal has selected a camera-off button.

Then, in S1330, the processor may display a capture notification on a display of the first user terminal for a first time period.

In embodiments, the processor may, after entering the multi-party photo capturing mode and before displaying the capture notification, receive a user input selecting a multi-party photo capturing button from the first user, and while the capture notification is displayed, capture a first image including the first user using an image sensor of the first user terminal. The processor may receive a second image including the second user from the second user terminal, and then generate a composite image by combining the first image and the second image. In contrast to receiving the second image from the second user terminal, the processor may acquire a screenshot of the second image including the second user displayed on the display, and generate the composite image by combining the first image and the second image.

In embodiments, the processor may, after entering the multi-party photo capturing mode and before displaying the capture notification, display a capture preparation notification on the display for a second time period. At this time, the second time period may be longer than the first time period. In addition, the processor may deactivate a camera-off button and a multi-party photo capturing mode exit button while displaying the capture preparation notification.

In embodiments, the processor may measure a data communication delay between the first user terminal and the second user terminal. At this time, a time point for displaying the capture preparation notification on the display is determined based on the measured communication delay, and based on the measured communication delay, a first image and a second image may be captured at the same timing (or contemporaneously) on the first user terminal and the second user terminal.

In embodiments, the processor may, while the capture notification is displayed, capture a first image including the first user for a third time period using an image sensor of the first user terminal. At this time, the first time period may be longer than the third time period by a predetermined (or alternatively, given) time (may also be referred to herein as a first time amount) or more. In addition, a time point at which the third time period for capturing the first image ends may be the same as (or similar to) or earlier than a time point at which the first time period for displaying the capture notification ends.

In embodiments, the processor may, after entering the multi-party photo capturing mode and before displaying a capture notification, display a plurality of photo themes on a display, receive a user input selecting one of the plurality of photo themes from a first user, display a first image sequence captured by an image sensor of the first user terminal in a first area of the selected photo theme on the display, display a second image sequence received from a second user terminal in a second area of the selected photo theme on the display, and receive a user input selecting a multi-party photo capturing button from the first user. At this time, when the processor displays the plurality of photo themes on the display, a visual object may be displayed together near a photo theme to which the second user provided feedback. In addition, a first pose guide may be displayed overlaid on the first image sequence in the first area, and a second pose guide may be displayed overlaid on the second image sequence in the second area.

In embodiments, the processor may, after entering a multi-party photo capturing mode, in response to determining that the number of users participating in the multi-party photo capturing mode is less than or equal to a predetermined (or alternatively, given) number, display a first image sequence captured by an image sensor of the first user terminal in a first area of a display, and display a second image sequence received from a second user terminal in a second area of the display.

In contrast, the processor may, after entering a multi-party photo capturing mode, in response to determining that the number of users participating in the multi-party photo capturing mode is greater than a predetermined (or alternatively, given) number, display a second image sequence received from a second user terminal in a second area of a display. At this time, a first image sequence captured by an image sensor of the first user terminal may not be displayed on the display. Thereafter, the processor may, in response to determining that a user participating in the multi-party photo capturing mode has exited and that the number of users participating in the multi-party photo capturing mode is less than or equal to the predetermined (or alternatively, given) number, display the first image sequence captured by the image sensor of the first user terminal in a first area of the display.

Thereafter, in S1340, the processor may display a composite image, in which a first image including the first user and a second image including the second user are combined, on the display. In embodiments, the composite image may include a plurality of layers, and an image captured at a user terminal that first entered the multi-party photo capturing mode among the first user terminal and the second user terminal may be arranged in an upper layer.

In embodiments, the processor may transmit a composite image to a second user terminal via a chat room. At this time, in response to receiving a user input selecting a multi-party photo capturing mode exit button from the first user, the composite image may be transmitted to the second user terminal via the chat room. For example, the composite image may be uploaded to a chat room including the first user and the second user, and the uploaded image may be downloaded to the second user terminal.

The flowchart shown in FIG. 12 and FIG. 13 and the above description are only an example, and may be implemented differently in other examples. For example, the order of some operations may be changed, some operations may be omitted, or other configurations may be added, and some operations described as being performed sequentially may be performed simultaneously (or contemporaneously).

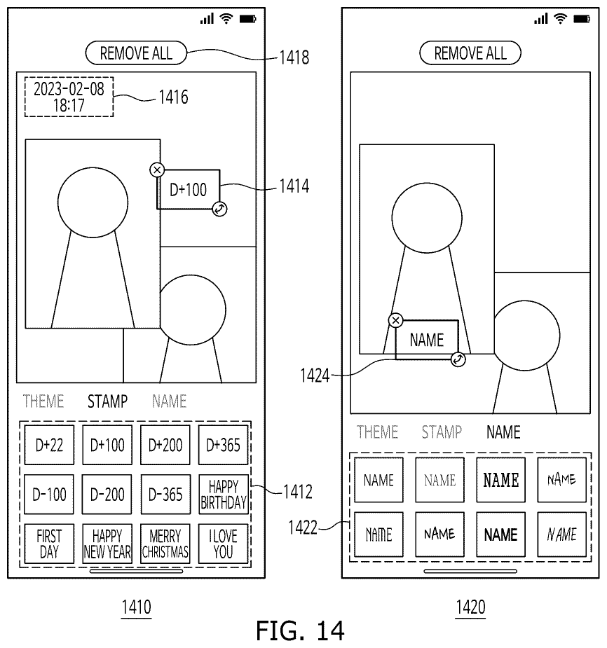

FIG. 14 is a diagram illustrating an example in which a stamp 1414 or a visual object 1424 including user information is displayed on a composite image according to embodiments of the present disclosure. A first operation 1410 shows an example in which a selected stamp 1414 is displayed on a composite image according to a user input selecting one of a plurality of stamp templates in an area 1412. In embodiments, a user (or, a host) may add a stamp 1414 on the composite image by selecting at least one of a plurality of stamp templates, and change the position of the added stamp 1414, or rotate or remove the displayed stamp.

A plurality of stamp templates may include a D-day, an anniversary phrase, a greeting expression, etc., and may be expressed in various styles (font, decoration effect, etc.). Additionally, a user may modify the content of a stamp template or add a new stamp template.

In embodiments, a template representing a D-day may correspond to one associated with a user in a chat room or a user conducting a video call. For example, a template representing a D-day may be generated based on anniversary information associated with a guest and a host stored in an instant messaging application and the current date. In another example, if the current date corresponds to the birthday of at least some of the users in a chat room, a ‘Happy Birthday’ stamp template may be displayed in an area 1412.

Additionally, information associated with the current time (or, the current call time) may be further displayed on the composite image. For example, the current time may be displayed in a top-left area 1416 of the composite image, but is not limited thereto. In addition, the current video call/voice call time in the chat room (e.g., 18 minutes 17 seconds) may be further displayed in the top-left area 1416.

A user (or, a host) may remove all stamps, user information, etc., displayed on a composite image by selecting a button 1418.

A second operation 1420 shows an example in which a visual object 1424 including user information is displayed on a composite image according to a user input selecting one of a plurality of user information templates in an area 1422. In embodiments, a user (or, a host) may display a visual object 1424 representing user information (e.g., chat name, name, status information, etc.) on the composite image by selecting at least one of a plurality of user information templates, and change the position of the displayed visual object 1424, or rotate or remove the visual object 1424. The user may change the user's information displayed in the visual object 1424.

A plurality of user information templates may be expressed in various styles (font, decoration effect, etc.). Additionally, a user may modify the design of a stamp template or add a new stamp template.

Conventional devices and methods for performing a video call are only capable of enabling a participant in the video call to capture an image of a screen from the ongoing video stream of the video call. However, such an approach results in inferior captured images because the other participant(s) in the video call are not prepared to pose for the image capture.

However, according to embodiments, improved devices and methods are provided for capturing an image during a video call. For example, the improved devices and methods enable a multi-party capturing mode during the video call that involves displaying a capture notification indicating a time point at which the image will be captured. This enables other participants to prepare to pose for the image before the image is captured. Also, the improved devices and methods may enable the image to be captured according to one or more themes and/or poses, thereby providing a photobooth experience during the video call. Accordingly, the improved devices and methods overcome the deficiencies of the conventional devices and methods to at least improve the quality of group images captured during a video call, and/or enable a photobooth experience during the video call.

According to embodiments, operations described herein as being performed by the information processing system 230, each of a plurality of user terminals 210_1, 210_2, and 210_3, the user terminal 210, the processor 314, the communication module 316, the input/output interface 318, the processor 334, the communication module 336, the input/output interface 338, the image capturing unit 410, the image preprocessing unit 420, the image combining unit 430, the image post-processing unit 440, the host terminal 1210, and/or the guest terminal 1220 to may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), a digital signal processor, a microcomputer, a field programmable gate array (FPGA), a System-on-Chip (SoC), a programmable logic unit, a microprocessor, application-specific integrated circuit (ASIC), etc.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm, and/or functions, described in connection with embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

The above-described method may be provided as a computer program stored in a non-transitory computer-readable recording medium for execution on a computer. The medium may continuously store a computer-executable program, or may temporarily store it for execution or download. In addition, the medium may be various recording means or storage means in the form of a single or several hardware combined, but is not limited to a medium directly connected to a certain computer system, and may be distributed on a network. Examples of the medium may include a magnetic medium such as a hard disk, a floppy disk, and a magnetic tape, an optical recording medium such as a CD-ROM and a DVD, a magneto-optical medium such as a floptical disk, and one configured to store program instructions, including a ROM, a RAM, a flash memory, and the like. In addition, as another example of the medium, a recording medium or a storage medium managed by an app store that distributes applications or a site, a server, etc., that supplies or distributes various other software may also be included.

The methods, operations, or techniques of the present disclosure may also be implemented by various means. For example, these techniques may be implemented in hardware, firmware, software, or a combination thereof. Those of ordinary skill in the art will understand that the various illustrative logical blocks, modules, circuits, and algorithm operations described in connection with the disclosure herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. A person of ordinary skill in the art may implement the described functionality in varying ways for each particular application, but such implementation decisions should not be interpreted as causing a departure from the scope of the present disclosure.

In a hardware implementation, the processing units used to perform the techniques may be implemented within one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the present disclosure, a computer, or a combination thereof.

Accordingly, the various illustrative logical blocks, modules, and circuits described in connection with the present disclosure may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In a firmware and/or software implementation, the techniques may be implemented as instructions stored on a non-transitory computer-readable medium, such as random access memory (RAM), read-only memory (ROM), non-volatile random access memory (NVRAM), programmable read-only memory (PROM), erasable programmable read-only memory (EPROM), electrically erasable PROM (EEPROM), flash memory, a compact disc (CD), a magnetic or optical data storage device, and the like. The instructions may be executable by one or more processors and may cause the processor(s) to perform certain aspects of the functionality described in the present disclosure.

Although embodiments described above have been described as utilizing aspects of the presently disclosed subject matter in one or more standalone computer systems, the present disclosure is not limited thereto and may be implemented in conjunction with any computing environment, such as a network or a distributed computing environment. Furthermore, aspects of the subject matter in the present disclosure may be implemented in a plurality of processing chips or devices, and storage may be similarly affected across a plurality of devices. Such devices may include PCs, network servers, and portable devices.

Although terms of “first” or “second” may be used to explain various components, the components are not limited to the terms. These terms should be used only to distinguish one component from another component. For example, a “first” component may be referred to as a “second” component, or similarly, and the “second” component may be referred to as the “first” component. Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples. As used herein the term “and/or” includes any and all combinations of one or more of the associated listed items.

Any of the arrows or lines that interconnect the components in the drawings may represent physical data paths, logical data paths, or both. A physical data path may comprise a data bus or a transmission line, for example. A logical data path may represent a communication or data message between software programs, software modules, subroutines, or other software constituents or components.

Although the present disclosure has been described in this specification in connection with embodiments, various modifications and changes may be made without departing from the scope of the present disclosure, which may be understood by a person of ordinary skill in the art to which the present disclosure pertains. In addition, such modifications and changes should be considered to fall within the scope of the claims appended to this specification.

What is claimed is:

1. A method performed by at least one processor of a first user terminal for capturing an image during a video call, the method comprising:
initiating the video call between the first user terminal and a second user terminal, the first user terminal being associated with a first user, the second user terminal being associated with a second user, and the first user and the second user being included in a chat room of an instant messaging application;
entering a multi-party photo capturing mode during the video call;
displaying a capture notification on a display of the first user terminal for a first time period; and
displaying, on the display, a composite image in which a first image and a second image are combined, the first image including the first user, and the second image including the second user.

2. The method as claimed in claim 1, further comprising:
receiving a user input selecting a multi-party photo capturing button from the first user based on the entering the multi-party photo capturing mode;
capturing the first image using an image sensor of the first user terminal contemporaneous with the displaying the capture notification;
receiving the second image from the second user terminal; and
generating the composite image by combining the first image and the second image.

3. The method as claimed in claim 1, further comprising:
receiving a user input for multi-party photo capturing from the first user based on the entering the multi-party photo capturing mode;
capturing the first image using an image sensor of the first user terminal contemporaneous with the displaying the capture notification;
acquiring a screenshot of the second image displayed on the display; and
generating the composite image by combining the first image and the second image.

4. The method as claimed in claim 1, further comprising:
deactivating a multi-party photo capturing button in response to determining that the second user has selected a camera-off button.

5. The method as claimed in claim 1, further comprising:
displaying a capture preparation notification on the display for a second time period based on the entering the multi-party photo capturing mode,
wherein the second time period is longer than the first time period.

6. The method as claimed in claim 5, further comprising:
deactivating a camera-off button and a multi-party photo capturing mode exit button contemporaneous with the displaying the capture preparation notification.

7. The method as claimed in claim 1, further comprising:
capturing the first image for a third time period contemporaneous with the displaying the capture notification, the capturing being performed using an image sensor of the first user terminal, the first time period being longer than the third time period by a first time amount or more.

8. The method as claimed in claim 7, wherein a time point at which the third time period ends is the same as or earlier than a time point at which the first time period ends.

9. The method as claimed in claim 5, further comprising:
measuring a data communication delay between the first user terminal and the second user terminal to obtain a measured communication delay; and
determining a time point for displaying the capture preparation notification on the display based on the measured communication delay,
wherein the first image and the second image are captured contemporaneously on the first user terminal and the second user terminal based on the measured communication delay.

10. The method as claimed in claim 1, further comprising:
displaying a plurality of photo themes on the display based on the entering the multi-party photo capturing mode;
receiving a first user input from the first user selecting a first photo theme from among the plurality of photo themes;
displaying, on the display, a first image sequence captured by an image sensor of the first user terminal in a first area of the first photo theme;
displaying, on the display, a second image sequence received from the second user terminal in a second area of the first photo theme; and
receiving a second user input from the first user selecting a multi-party photo capturing button.

11. The method as claimed in claim 10, wherein the displaying the plurality of photo themes includes displaying a visual object near a second photo theme to which the second user provided feedback, the second photo theme being among the plurality of photo themes.

12. The method as claimed in claim 10, further comprising:
displaying a first pose guide overlaid on the first image sequence in the first area; and
displaying a second pose guide overlaid on the second image sequence in the second area.

13. The method as claimed in claim 1, wherein
the composite image comprises a plurality of layers; and
a third image is in an upper layer among the plurality of layers, the third image being one of,
the first image based on the first user terminal entering the multi-party photo capturing mode before the second user terminal, or
the second image based on the second user terminal entering the multi-party photo capturing mode before the first user terminal.

14. The method as claimed in claim 1, further comprising:
displaying a first image sequence in a first area of the display in response to determining that a number of users participating in the multi-party photo capturing mode is less than or equal to a first number, the displaying the first image sequence being performed based on the entering the multi-party photo capturing mode, and the first image sequence being captured by an image sensor of the first user terminal; and
displaying a second image sequence in a second area of the display, the second image sequence being received from the second user terminal.

15. The method as claimed in claim 1, further comprising:
displaying a first image sequence in a first area of the display in response to determining that a number of users participating in the multi-party photo capturing mode is greater than a first number, the displaying the first image sequence being performed based on the entering the multi-party photo capturing mode, and the first image sequence being received from the second user terminal,
wherein a second image sequence captured by an image sensor of the first user terminal is not displayed on the display in response to determining that the number of users participating in the multi-party photo capturing mode is greater than the first number.

16. The method as claimed in claim 15, further comprising:
displaying the second image sequence in a second area of the display in response to determining that a user participating in the multi-party photo capturing mode has exited and that the number of users participating in the multi-party photo capturing mode is less than or equal to the first number.

17. The method as claimed in claim 1, further comprising:
transmitting the composite image to the second user terminal via the chat room.

18. The method as claimed in claim 17, wherein the transmitting is performed in response to receiving a user input from the first user selecting a multi-party photo capturing mode exit button.

19. A computer-readable non-transitory recording medium on which are recorded instructions that, when executed by a computer, cause the computer to perform the method according to claim 1.

20. A first user terminal comprising:
a display;
a memory; and
at least one processor connected to the memory and configured to execute at least one computer-readable program included in the memory to cause the first user terminal to,
initiate a video call between the first user terminal and a second user terminal, the first user terminal being associated with a first user, the second user terminal being associated with a second user, and the first user and the second user being included in a chat room of an instant messaging application,
enter a multi-party photo capturing mode during the video call,
display a capture notification on the display for a first time period, and
display, on the display, a composite image in which a first image and a second image are combined, the first image including the first user, and the second image including the second user.
